(19) United States
(12) Patent Application Publication
(10) Pub. No.: US 2006/0140588 A1
(43) Pub. Date: Jun. 29, 2006

(54) Apparatus and method of inserting personal data using digital caption

(75) Inventor: Kwang-won Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/237,870

(22) Filed: Sep. 29, 2005

(30) Foreign Application Priority Data
Dec. 27, 2004 (KR) 2004-112898

(51) Int. Cl. H04N 7/52; H04N 7/08

(52) U.S. Cl. 386/95; 348/473; 348/564

(57) ABSTRACT

Disclosed are an apparatus and method of inserting personal data using digital caption. A digital receiver, which has a function of separating an analog caption from an input digital stream, inserts a user edited data to the analog caption, and outputs the analog caption carrying the user edited data to a TV screen. Thus, not only can the user insert his personal data into the broadcasting contents, but also keep the data for a long time by recording it to data storage medium such as a VCR.

### CROSS-REFERENCE TO RELATED APPLICATIONS

This application claims benefit under 35 U.S.C. § 119 from Korean Patent Application No. 2004-112898, filed on Dec. 27, 2004, the entire content of which is incorporated herein by reference.

### BACKGROUND OF THE INVENTION

1. Field of the Invention

The present invention relates in general to an apparatus and method of inserting personal data using a digital caption, and more specifically, to an apparatus and method of inserting caption data, wherein a digital receiver inserts personal data a viewer edited into an analog video signal in caption data format, and outputs the analog video signal to a TV screen for the viewer to watch or record (e.g., on a VCR) if desired.

2. Description of the Related Art

Most television broadcasting contents include captions. As a rule, there are two types of captions: open captions and closed captions. Open captions are decoded as an integral part of a TV picture (oftentimes called ‘subtitles’). In other words, open captions cannot be turned off but display on the TV screen everything transmitted from a TV station. In contrast, closed captions are hidden in the video signal, and are only displayable by using a special decoder having a ‘caption’ receiving function. That is, open captions are displayed automatically, irrespective of the viewer's wishes. For instance, some news bulletins, presidential addresses, staff introductions, titles of songs, names of singers, announcements for civil defense drills, and translations of foreign language moves are open captioned. On the other hand, closed captions are provided for viewers who want written dialogue of TV programs or specific additional information. For instance, closed captions benefit the hearing impaired or non-native speakers or those who may find written language (dialogue in movies and TV programs) easier to understand.

For many years, the NTSC (National Television Standards Committee) system has played a dominant role in transmission of captioned TV programs. With the widespread availability of digital TV technologies in recent years, both NTSC TVs and digital TVs are used interchangeably.

The caption services are provided via different transmission mediums such as a ground wave, cable or satellite (although each is different). Also, EIA608 caption data are carried not only in NTSC broadcasting but also in digital broadcasting.

Digital TV (DTV) caption data is transmitted to a viewer through a user data region of a bitstream.

The user data region is composed of NTSC caption data in line 21 of an NTSC signal, and a channel for transmitting DTVCC caption data. Here, the NTSC caption data conforms to EIA (Electronic Industries Association) 608 standard, and DTVCC caption data conforms to EIA708 standard.

In a particular broadcasting program, not only EIA708 caption data but also EIA708 caption data are inputted to an input data stream of a digital caption data processing system. For instance, cable broadcasting and satellite digital broadcasting carry both EIA708 (CC1, CC2, . . . , Service1, Service2, . . . ) caption data and EIA608 (CC1, CC2, CC3, CC4) caption data.

In that case, a digital signal receiving device decodes the EIA608 digital caption data to conform to the analog caption standard, and outputs a composite video base-band signal (CVBS), to which the analog caption data is inserted, to outside the device, whereby a viewer can watch it on an analog TV. More specifically, the digital signal receiving device extracts EIA608 caption data from caption user data, and inserts it into line 21 of a CVBS signal in response to an interrupt signal. The inserted caption data is then outputted through a TV set providing analog caption services.

The analog caption services are convenient in that digital captions can be converted and displayed as analog captions. However, the viewer cannot insert writings or notes he randomly edited into the caption and use them later.

### SUMMARY OF THE INVENTION

It is, therefore, an aspect of the present invention to provide an apparatus and method of inserting personal data such as writings and notes a viewer (or user) edited using analog caption services into a CVBS as caption data and outputting the inserted caption data.

To achieve the above aspect and advantages, there is provided a method of inserting personal data into an output signal from a digital signal receiving device, in which a user first edits data and the edited data is inserted into the output signal in caption data format, and if desired, the user can record the caption information.

Given that an analog TV signal (CVBS) can be separated from an input data stream of an input channel, a user is able to edit the data and the digital signal receiving device inserts the caption information into the analog TV signal.

Preferably, but not necessarily, the data editing includes: in the digital signal receiving device, selecting a caption editing service mode selected by a user; displaying an editing screen including an onscreen keyboard or another input unit; and editing data using the onscreen keyboard or another input unit.

Another aspect of the present invention provides an apparatus for inserting data into an output signal from a digital signal receiving device, in which the apparatus includes a display unit; a memory for storing an editing screen including an onscreen keyboard; and a decoder for displaying the editing screen on the display unit, inserting edited data into an analog TV signal in caption data format, and outputting the analog TV signal carrying the caption data.

The apparatus may be configured so that data editing through the decoder is possible only if the analog TV signal (CVBS) is outputted from an input data stream of an input channel. Also, if a user selects a caption editing service mode through the input unit, the decoder displays the editing screen on the display unit.

### BRIEF DESCRIPTION OF THE DRAWINGS

The above aspects and features of the present invention will be more apparent by describing exemplary embodiments of the present invention with reference to the accompanying drawings, in which:

FIG. 1 is a schematic block diagram of a digital signal receiving device for analog caption data processing;

FIG. 2 illustrates an example of a TV screen to which a caption is inputted; and

FIG. 3 is a flow chart explaining a method of inputting an analog caption according to one embodiment of the present invention.

### DETAILED DESCRIPTION OF EXEMPLARY EMBODIMENTS

An exemplary embodiment of the present invention will be described herein below with reference to the accompanying drawings.

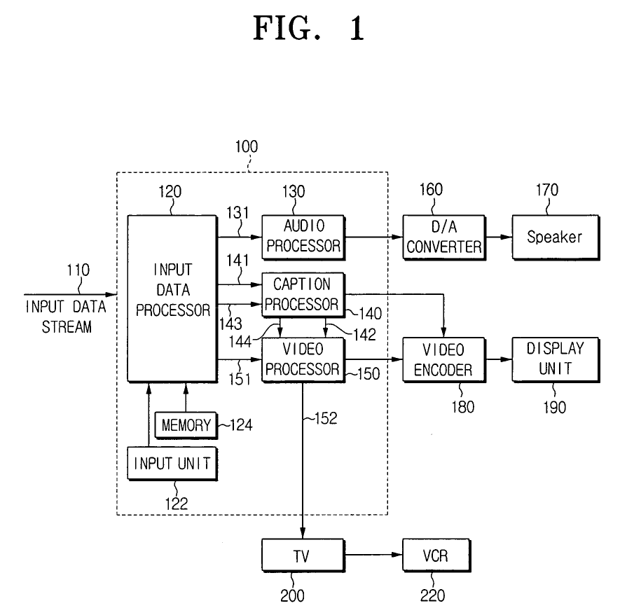

FIG. 1 is a schematic block diagram of a digital signal receiving device for analog caption data processing. As shown in FIG. 1, the digital signal receiving device includes Micom or decoder 100 (hereinafter it will be referred to as decoder), a D/A converter 160, a speaker 170, a video encoder 180, a display unit 190, an analog TV 200, and a VCR 220.

The decoder 100 includes an input data processor 120, an input unit 122, a memory 124, an audio processor 130, a caption processor 140, and a video processor 150.

The input unit 122 is composed of three parts: a mode selection key enabling a user to select a desired mode out of caption mode and caption editing service mode, right and left arrow keys enabling a user to select a desired text on a screen keyboard, and an editing complete key. These are for illustrative purposes only, and so, if necessary, other input tools can be used as well.

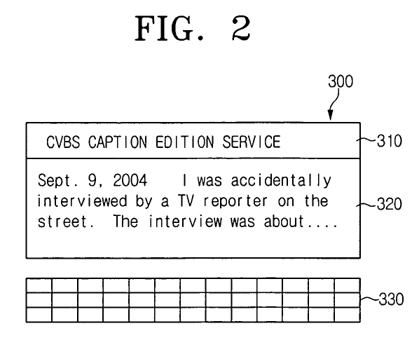

The memory 124 stores a caption editing service related GUI 300. This caption editing service related GUI 300, as shown in FIG. 2, shows a title “CVBS caption editing service” on the upper part 310 of the screen, a relevant key input unit enabling the user to use the onscreen keyboard on the lower part 330, and edited sentence(s) at the central part 320. The user is able to move the onscreen keyboard on the lower part 330 in every direction by using the right and left arrow keys of the input unit 122, and input characters such as the English and Korean alphabets, and numbers. Preferably, but not necessarily, the central part 320 displaying the edited sentence(s) has a scroll function to scroll 3 lines of sentence(s) in general. To change a line, the user can use a CR (Carriage Return) key on the onscreen keyboard.

The input data processor 120 receives a data stream 110 from outside, and separates the input data stream 110 into audio information 131, caption information 141, and video information 151. The audio processor 180 receives the audio information outputted from the input data processor 120, and performs signal processing on the audio information to output through the speaker 170.

If the user selects the caption editing service through the input unit 122, the input data processor 120 reads the caption editing service related GUI 300 from the memory 124 and displays it on the display unit 190, thereby allowing the user to edit. When editing is complete, the input data processor 120 transmits user input caption data 143 to the caption processor 140.

If the user selects the caption mode through the input unit 122, the caption processor 140 decodes and standardizes the caption information 141 from the input data processor 120, in order for the caption information 141 to be combined with a converted video signal by the video encoder 180 and be outputted to the display unit 190. Usually, the caption processor 140 is composed of a receiver for receiving caption data from the input data processor 120, a module for parsing the received data, and a display module for drawing a caption. Functions or constructions of these elements will not be described in detail since they are well-know and would obscure the invention in unnecessary detail.

Particularly, the caption processor 140 extracts a factor for distinguishing between an EIA708 caption and an E1608 caption from a flag for user data, and extracts EIA608 caption information 142, which is the caption data to be inserted into the CVBS. Then, the caption processor 140 transmits the data to the video processor 150, which carries the data into a CVBS analog signal 152 in caption data format.

If the caption data 143 the user edited is provided from the input data processor 120 the caption processor 140 transmits user caption data 144 to the video processor 150 so that the input caption data can be processed to be inserted into the CVBS analog signal 152.

The video processor 150 receives the video information 151 that is outputted from the input data processor 120, and performs signal processing so that the video information 151 is displayable on the display 190. More specifically, the video processor 150 reconstructs a pictorial image or video from compressed data, and transmits an internationally standardized video signal to the video encoder 180. Further, the video processor 150 inserts the EIA608 caption information 142 transmitted from the caption processor 140 into the CVBS analog signal 152 in caption data format, and outputs the signal carrying the EIA608 caption information.

In addition, the video processor 150 inserts, in response to an interrupt signal, the user caption data 144 transmitted from the caption processor 140 into the CVBS analog signal 152, and outputs the signal carrying the user caption data. Needless to say, the EIA608 caption information 142, which is the CVBS caption data, is not extracted. That is, when editing is complete and the editing complete key in the input unit 122 is executed, the user caption data 144, instead of the CVBS caption data, is inserted into the CVBS signal at a proper speed in response to the interrupt signal. Since the procedure involved in the insertion of the user caption data 144 is the same as that of the insertion of CVBS caption information in general, it will not be described in more detail.

The video encoder 180 converts RGB information into an analog NTSC signal which the display unit 150 can receive, and outputs the converted signal. Moreover, the video encoder 180 combines the caption information from the caption processor 140 with the video signal, and outputs the result to the display unit 150.

The D/A converter 160 converts a digital signal outputted from the audio processor 130 into an analog signal, and outputs the analog signal to the speaker 140.

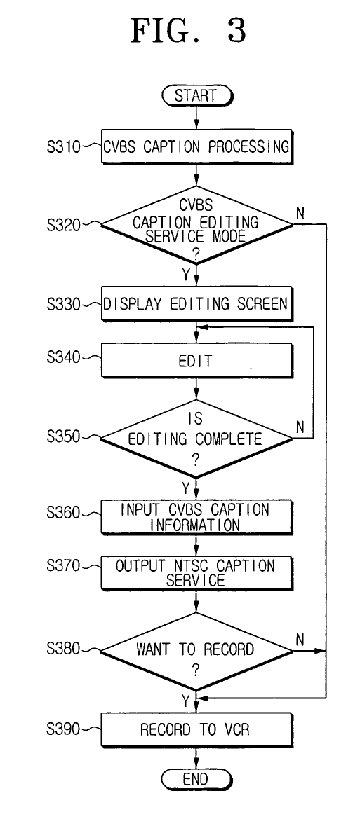

The following will explain how to input an analog caption, according to one embodiment of the present invention. FIG. 3 is a flow chart describing the method of inputting an analog caption. As can be seen in FIG. 3, the input data processor 120 of the decoder 100 separates the caption information 141 from the input data stream of an input channel, and performs signal processing, whereby the decoded EIA608 caption information 142 from the caption processor 140 is inserted into the CVBS analog signal 152 by the video processor 150 (S310). If the user selects the CVBS caption editing service mode through the input unit 122 (S320), the input data processor 120 reads the caption editing service related GUI 300 from the memory 124, and displays it on the display unit 190 (S330). Then, the user edits the text or writings through the input unit 122, and the editing result is shown on the screen (S340). Preferably, but not necessarily, the CVBS caption editing service mode is selected only if the EIA608 caption information 142 has been inserted into the caption information 141. Reading the EIA608 caption information 142 indicates a case where “0X03” code in user data of the typical input data stream 110 is inputted.

When editing is complete and the editing complete key is operated (S350), the input data processor 120 transmits the caption data 143 the user edited to the caption processor 140, to make the video processor 150 insert the corresponding caption data into the CVBS signal in caption data format in response to the interrupt signal (S360).

As aforementioned, the caption data is inserted into the CVBS signal, more specifically, the NTSC caption information is inserted into line 21 of the CVBS signal. Then, the video processor 150 outputs the CVBS analog signal 152 carrying the NTSC caption information, thereby enabling the user to watch the edited caption data 143 on the analog TV 200 (S370).

If the user wants to keep the CVBS analog signal 152 carrying the user caption data 144 (S380), he can record it to the VCR 220 (S390).

Although the above-described embodiment of the present invention introduced the method of inserting user caption data (or personal data) into an analog signal using the EIA608 caption information, the same method can be applied to a digital caption as well. In other words, even if the EIA708 caption information is inputted, it is possible to insert the user caption data (or personal data) into a digital signal.

In conclusion, the apparatus and method of inserting personal data using a digital caption makes it possible for the user to insert personal data directly into the caption that is actually being broadcasted as part of the broadcasting contents. Thus, not only can the user insert personal data into the broadcasting contents, but the user can also keep the data for a long time by recording it with a recording device such as a VCR.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method of inserting personal data into an output signal from a digital signal receiving device, the method comprising:
editing the data; and
inserting the edited data into the output signal in caption data format.

2. The method according to claim 1, further comprising recording the caption data.

3. The method according to claim 1, wherein the output signal is an analog TV signal.

4. The method according to claim 1, wherein the data editing comprises:
in the digital signal receiving device, selecting a caption editing service mode;
displaying an editing screen including an onscreen keyboard; and
editing data using the onscreen keyboard.

5. The method according to claim 4, wherein the data editing on the onscreen keyboard is accomplished by scrolling down three lines followed by a carriage return.

6. An apparatus for inserting data into an output signal from a digital signal receiving device, the apparatus comprising:
a display unit;
a memory configured to store an editing screen including an onscreen keyboard; and
a decoder configured to display the editing screen on the display unit, to insert edited data into an analog TV signal in caption data format, and to output the analog TV signal carrying the caption data.

7. The apparatus according to claim 6, wherein the data editing through the decoder is possible only if the analog TV signal (CVBS) is outputted from an input data stream of an input channel.

8. The apparatus according to claim 7, further comprising an input unit configured to enable a user to select a caption editing service mode, whereby if the caption editing service mode is selected through the input unit the decoder displays the editing screen on the display unit.

9. The apparatus according to claim 8, wherein the data editing on the editing screen through the input unit is accomplished by scrolling down three lines followed by a carriage return.
